(19) United States
(12) Patent Application Publication
(10) Pub. No.: US 2025/0040604 A1
(43) Pub. Date: Feb. 6, 2025

(54) AERSOL GENERATING DEVICE INCLUDING HEATER AND MANUFACTURING METHOD THEREOF

(71) Applicant: KT&G CORPORATION, Daejeon (KR)

(72) Inventors: Wonkyeong LEE, Guri-si (KR); Min Kyu KIM, Seoul (KR); Paul Joon SUNWOO, Seoul (KR)

(73) Assignee: KT&G CORPORATION, Daejeon (KR)

(21) Appl. No.: 18/276,992

(22) PCT Filed: May 4, 2023
(86) PCT No.: PCT/KR2023/006097

§ 371 Date: Aug. 11, 2023

(30) Foreign Application Priority Data
May 23, 2022 (KR) 10-2022-0062743
Jul. 26, 2022 (KR) 10-2022-0092177

(51) Int. Cl. A24F 40/46; A24F 40/20; A24F 40/70; H05B 3/46

(52) U.S. Cl. CPC A24F 40/46; A24F 40/20; A24F 40/70; H05B 3/46

(57) ABSTRACT

According to various embodiments, an aerosol generating device for generating an aerosol by heating a cigarette includes a pipe including an opening into which the cigarette is inserted, a first surface enclosing at least a partial region of an outer circumferential surface of the cigarette when the cigarette is inserted, and a second surface opposite to the first surface, a heater provided on the second surface of the pipe and configured to heat the pipe, and an insulating layer configured to provide electrical insulation and provided between the heater and the second surface of the pipe, wherein the heater includes a heating wire printed directly on the second surface and the insulating layer in a pattern enclosing at least a partial region of the second surface of the pipe.

### TECHNICAL FIELD

The following embodiments relate to an aerosol generating device including a heater and a manufacturing method thereof.

### BACKGROUND ART

Recently, demands for alternative ways to overcome disadvantages of general cigarettes have increased. For example, there is an increasing demand for a device (e.g., an electrically heated tobacco product) that generates an aerosol by electrically heating a cigarette stick. Accordingly, research on an electrically heated aerosol generating device and a cigarette stick (or an aerosol generating article) applied thereto is being actively conducted.

### DISCLOSURE OF INVENTION

### Technical Problem

An aerosol generating device and a manufacturing method thereof, according to various embodiments, provide a pipe into which a cigarette is inserted, the pipe being configured to heat the cigarette, and a heater for heating the pipe, wherein the connection structure of the heater and the pipe is simplified and high heat transfer efficiency of the aerosol generating device is achieved.

### Solution to Problem

According to an embodiment, an aerosol generating device for generating an aerosol by heating a cigarette may include a pipe including an opening into which the cigarette is inserted, a first surface enclosing at least a partial region of an outer circumferential surface of the cigarette when the cigarette is inserted, and a second surface opposite to the first surface, a heater provided on the second surface of the pipe and configured to heat the pipe, and an insulating layer configured to provide electrical insulation and arranged between the heater and the second surface of the pipe, wherein the heater may include a heating wire printed directly on the second surface and the insulating layer in a pattern enclosing at least a partial region of the second surface of the pipe.

In an embodiment, the aerosol generating device may include a connector configured to supply power to the heater and a plurality of terminals including a first terminal and a second terminal each connected to the connector.

In an embodiment, the heating wire may include one end portion connected to the first terminal and another end portion connected to the second terminal, the other end portion being opposite to the one end portion.

In an embodiment, the aerosol generating device may include a power supply unit connected to the connector and configured to supply power to the heater, wherein the connector may include a first connector terminal connected to the first terminal, a second connector terminal connected to the second terminal, a third connector terminal connected to the power supply unit, and a body made of a flexible printed circuit board (FPCB) and extending from the third connector terminal to the first connector terminal and the second connector terminal.

In an embodiment, the body of the connector may extend to the first connector terminal, the second connector terminal, and the third connector terminal from a center so as to form a Y-shape.

In an embodiment, the aerosol generating device may include a coating layer deposited on the second surface of the pipe and the heating wire.

In an embodiment, the insulating layer may be stacked on substantially an entire region of the second surface of the pipe.

In an embodiment, the insulating layer may be deposited on a partial region of the second surface of the pipe, the partial region corresponding to the pattern in which the heating wire is printed.

In an embodiment, the pipe may include, on the second surface, a groove inwardly formed to correspond to the pattern in which the heating wire is printed.

In an embodiment, the insulating layer and the heating wire may be placed in the groove on the second surface of the pipe.

According to an embodiment of the present disclosure, a method of manufacturing an aerosol generating device may include placing a pipe including an opening, an inner surface, and an outer surface opposite to the inner surface, stacking an insulating layer on the outer surface of the pipe, and printing a heating wire on the insulating layer on the outer surface of the pipe, wherein the printing of the heating wire may include printing the heating wire on the outer surface and the insulating layer in a pattern enclosing at least a partial region of the outer surface of the pipe.

In an embodiment, the stacking of the insulating layer may include stacking the insulating layer on substantially an entire region of the outer surface of the pipe.

In an embodiment, the stacking of the insulating layer may include stacking the insulating layer on a partial region of the outer surface of the pipe, the region corresponding to the pattern in which the heating wire is printed.

In an embodiment, the method may include, before the placing of the pipe, forming, on the outer surface of the pipe, a groove inwardly formed to correspond to the pattern in which the heating wire is printed.

In an embodiment, the method may include, after the printing of the heating wire, depositing a coating layer on the outer surface of the pipe and the heating wire.

### Advantageous Effects of Invention

According to an embodiment, in an aerosol generating device including a heater and a manufacturing method thereof, a heating wire, which is printed directly on a second surface of a pipe and heated, heats a pipe such that the pipe and the heating wire are integrated, and a structure may be simplified by omitting any additional structure to connect the heater and the pipe or enable them to be in close contact with each other.

Alternatively, according to an embodiment, in the aerosol generating device including the heater and the manufacturing method thereof, the heating wire of the heater is printed directly on the pipe, and thus, a heat loss that may occur during a heat transfer process between the heater and the pipe may decrease, and heat transfer efficiency may increase.

The effects of a charging system for the aerosol generating device according to an embodiment are not limited to the above-mentioned effects, and other unmentioned effects may be clearly understood from the following description by one of ordinary skill in the art.

### BRIEF DESCRIPTION OF DRAWINGS

FIG. 1 is a diagram illustrating an example of an aerosol generating article (e.g., a cigarette) inserted into an aerosol generating device according to various embodiments.

FIG. 2 is a diagram illustrating an example of an aerosol generating article (e.g., a cigarette) inserted into an aerosol generating device according to various embodiments.

FIG. 3 is a diagram illustrating an example of an aerosol generating article (e.g., a cigarette) according to various embodiments.

FIG. 4 is a diagram illustrating an example of an aerosol generating article (e.g., a cigarette) according to various embodiments.

FIG. 5 is a block diagram of an aerosol generating device according to various embodiments.

FIG. 6 is a perspective view illustrating coupling of an aerosol generating article (e.g., a cigarette) and an aerosol generating device according to an embodiment.

FIG. 7a is a planar figure of a pipe and a heater according to an embodiment.

FIG. 7b is a planar figure of a pipe and a heater according to an embodiment.

FIG. 8 is a cross-sectional view of an aerosol generating device according to an embodiment.

FIG. 9 is a cross-sectional view of an aerosol generating device according to an embodiment.

FIG. 10 is a cross-sectional view of an aerosol generating device according to an embodiment.

FIG. 11 is a flowchart of a method of manufacturing an aerosol generating device according to an embodiment.

### MODE FOR THE INVENTION

The terms used to describe the embodiments are selected from among common terms that are currently widely used, in consideration of their function in the disclosure. However, different terms may be used depending on an intention of one of ordinary skill in the art, a precedent, or the advent of new technology. Also, in particular cases, the terms are arbitrarily selected by the applicant of the disclosure, and the meaning of those terms will be described in detail in the corresponding part of the detailed description. Therefore, the terms used to describe the disclosure should be defined based on the meanings of the terms and all the content of the disclosure, rather than the terms themselves.

It will be understood that when a certain part “includes” a certain component, the part does not exclude another component but may further include another component, unless the context clearly dictates otherwise. Also, terms such as “unit,” “module,” etc., as used in the specification may refer to a part for processing at least one function or operation and which may be implemented as hardware, software, or a combination of hardware and software.

Hereinbelow, embodiments of the present disclosure will be described in detail with reference to the accompanying drawings so that the embodiments may be readily implemented by one of ordinary skill in the art to which the present disclosure pertains. However, the present disclosure may be implemented in many different forms and is not limited to the embodiments described herein.

Hereinafter, embodiments of the disclosure will be described in detail with reference to the drawings.

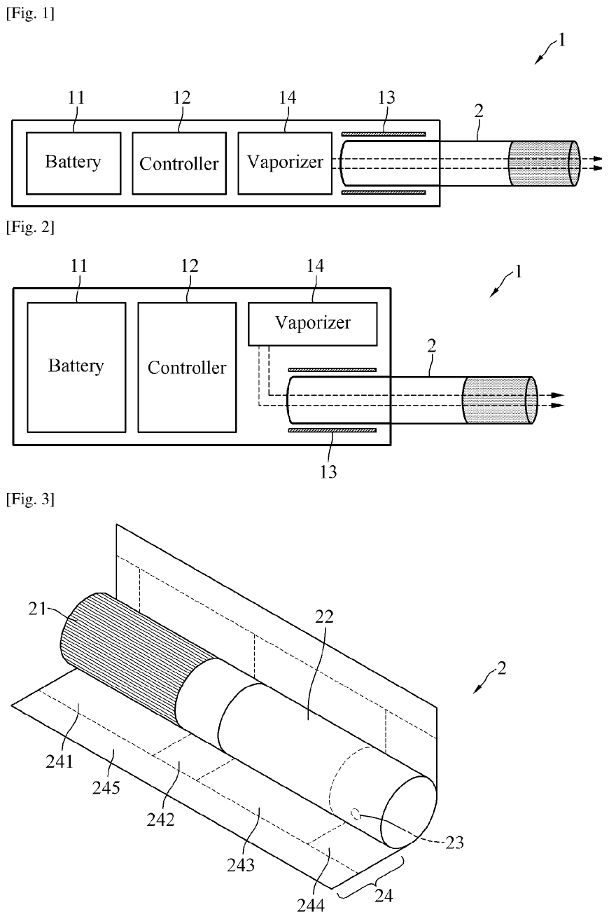

FIGS. 1 and 2 are diagrams illustrating examples of a cigarette inserted into an aerosol generating device.

Referring to FIG. 1, an aerosol generating device 1 according to an embodiment may include a battery 11, a controller 12, and a heater 13, and may further include a vaporizer 14 in an embodiment. A cigarette 2 may be inserted into an inner space of the aerosol generating device 1.

The aerosol generating device 1 shown in FIGS. 1 and 2 may include components related to the embodiments described herein. Therefore, it is to be understood by one of ordinary skill in the art to which the disclosure pertains that the aerosol generating device 1 may further include other general-purpose components in addition to the ones shown in FIGS. 1 and 2.

FIG. 1 illustrates a linear alignment of the battery 11, the controller 12, the vaporizer 14, and the heater 13. Further, FIG. 2 illustrates a parallel alignment of the vaporizer 14 and the heater 13. However, an internal structure of the aerosol generating device 1 is not limited to what is shown in FIGS. 1 and 2. That is, the alignments of the battery 11, the controller 12, the heater 13, and the vaporizer 14 may be changed depending on the design of the aerosol generating device 1.

When the cigarette 2 is inserted into the aerosol generating device 1, the aerosol generating device 1 may operate the heater 13 and/or the vaporizer 14 to generate an aerosol. The aerosol generated by the heater 13 and/or the vaporizer 14 may pass through the cigarette 2 into a user.

Even when the cigarette 2 is not inserted into the aerosol generating device 1, the aerosol generating device 1 may heat the heater 13, as needed.

The battery 11 may supply power to be used to operate the aerosol generating device 1. For example, the battery 11 may supply power to heat the heater 13 or the vaporizer 14, and may supply power required for the controller 12 to operate. In addition, the battery 11 may supply power required to operate a display, a sensor, a motor, or the like installed in the aerosol generating device 1.

The controller 12 may control the overall operation of the aerosol generating device 1. Specifically, the controller 12 may control respective operations of other components included in the aerosol generating device 1, in addition to the battery 11, the heater 13, and the vaporizer 14. In addition, the controller 12 may verify a state of each of the components of the aerosol generating device 1 to determine whether the aerosol generating device 1 is in an operable state.

The controller 12 may include at least one processor. The processor may be implemented as an array of a plurality of logic gates, or may be implemented as a combination of a general-purpose microprocessor and a memory in which a program executable in the microprocessor is stored. In addition, it is to be understood by one of ordinary skill in the art to which the present disclosure pertains that the processor may be implemented in other types of hardware.

The heater 13 may be heated by power supplied by the battery 11. For example, when a cigarette is inserted into the aerosol generating device 1, the heater 13 may be disposed outside the cigarette. The heated heater 13 may thus raise the temperature of an aerosol generating material in the cigarette.

The heater 13 may be an electrically resistive heater. For example, the heater 13 may include an electrically conductive track, and the heater 13 may be heated as a current flows through the electrically conductive track. However, the heater 13 is not limited to the foregoing example, and any example of heating the heater 13 up to a desired temperature may be applicable without limitation. Here, the desired temperature may be preset in the aerosol generating device 1 or may be set by the user.

As another example, the heater 13 may be an induction heater. Specifically, the heater 13 may include an electrically conductive coil for heating the cigarette in an induction heating manner, and the cigarette may include a susceptor to be heated by the induction heater.

For example, the heater 13 may include a tubular heating element, a plate-shaped heating element, a needle-shaped heating element, or a rod-shaped heating element, and may heat the inside or outside of the cigarette 2 according to the shape of a heating element.

In addition, the heater 13 may be implemented as a plurality of heaters in the aerosol generating device 1. In this case, the plurality of heaters 13 may be disposed in the cigarette 2, or may be disposed outside the cigarette 2. In addition, some of the heaters 13 may be disposed in the cigarette 2, and the rest may be disposed outside the cigarette 2. However, the shape of the heater 13 is not limited to what is shown in FIGS. 1 to 3 but may be provided in various shapes.

The vaporizer 14 may heat a liquid composition to generate an aerosol, and the generated aerosol may pass through the cigarette 2 into the user. That is, the aerosol generated by the vaporizer 14 may travel along an airflow path of the aerosol generating device 1, and the airflow path may be configured such that the aerosol generated by the vaporizer 14 may pass through the cigarette to the user.

For example, the vaporizer 14 may include a liquid storage, a liquid transfer means, and a heating element. However, embodiments are not limited thereto. For example, the liquid storage, the liquid transfer means, and the heating element may be included as independent modules in the aerosol generating device 1.

The liquid storage may store the liquid composition. For example, the liquid composition may be a liquid including a tobacco-containing material having a volatile tobacco flavor ingredient, or a liquid including a non-tobacco material. The liquid storage may be manufactured to be detachable from the vaporizer 14, or may be manufactured in an integral form with the vaporizer 14.

The liquid composition may include, for example, water, a solvent, ethanol, a plant extract, a fragrance, a flavoring agent, or a vitamin mixture. The fragrance may include, for example, menthol, peppermint, spearmint oil, various fruit-flavored ingredients, and the like. However, embodiments are not limited thereto. The flavoring agent may include ingredients that provide the user with a variety of flavors or scents. The vitamin mixture may be a mixture of at least one of vitamin A, vitamin B, vitamin C, or vitamin E, but is not limited thereto. The liquid composition may also include an aerosol former such as glycerin and propylene glycol.

The liquid transfer means may transfer the liquid composition in the liquid storage to the heating element. The liquid transfer means may be, for example, a wick such as cotton fiber, ceramic fiber, glass fiber, or porous ceramic. However, embodiments are not limited thereto.

The heating element may be an element configured to heat the liquid composition transferred by the liquid transfer means. The heating element may be, for example, a metal heating wire, a metal heating plate, a ceramic heater, or the like. However, embodiments are not limited thereto. In addition, the heating element may include a conductive filament such as a nichrome wire, and may be arranged in a structure wound around the liquid transfer means. The heating element may be heated as a current is supplied and may transfer heat to the liquid composition in contact with the heating element, and may thereby heat the liquid composition. As a result, an aerosol may be generated.

For example, the vaporizer 14 may also be referred to as a cartomizer or an atomizer. However, embodiments are not limited thereto.

The aerosol generating device 1 may further include general-purpose components in addition to the battery 11, the controller 12, the heater 13, and the vaporizer 14. For example, the aerosol generating device 1 may include a display that outputs visual information and/or a motor that outputs tactile information. In addition, the aerosol generating device 1 may include at least one sensor (e.g., a puff sensor, a temperature sensor, a cigarette insertion detection sensor, etc.). In addition, the aerosol generating device 1 may be manufactured to have a structure allowing external air to be introduced or internal gas to flow out even while the cigarette 2 is inserted.

Although not shown in FIGS. 1 and 2, the aerosol generating device 1 may constitute a system along with a separate cradle. For example, the cradle may be used to charge the battery 11 of the aerosol generating device 1. Alternatively, the cradle may be used to heat the heater 13, with the cradle and the aerosol generating device 1 coupled.

The cigarette 2 may be similar to a general combustible cigarette. For example, the cigarette 2 may be divided into a first portion including an aerosol generating material and a second portion including a filter or the like. Alternatively, the second portion of the cigarette 2 may also include the aerosol generating material. For example, the aerosol generating material provided in the form of granules or capsules may be inserted into the second portion.

The first portion may be entirely inserted into the aerosol generating device 1, and the second portion may be exposed outside. Alternatively, only the first portion may be partially inserted into the aerosol generating device 1, or the first portion may be entirely inserted into the aerosol generating device 1 and the second portion may be partially inserted into the aerosol generating device 1. The user may inhale an aerosol with the second portion in a mouth of the user. In this case, an aerosol may be generated as external air passes through the first portion, and the generated aerosol may pass through the second portion into the mouth of the user.

For example, the external air may be introduced through at least one air path formed in the aerosol generating device 1. In this example, opening or closing and/or the size of the air path formed in the aerosol generating device 1 may be adjusted by the user. Accordingly, an amount of atomization, a sense of smoking, or the like may be adjusted by the user. As another example, the external air may be introduced into the inside of the cigarette 2 through at least one hole formed on a surface of the cigarette 2.

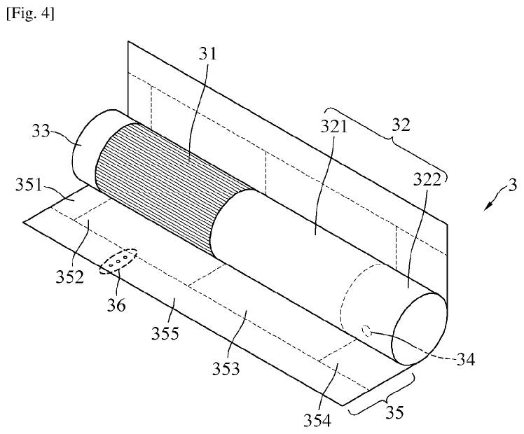

Hereinafter, examples of the cigarette 2 will be described with reference to FIGS. 3 and 4.

FIGS. 3 and 4 are diagrams illustrating examples of a cigarette.

Referring to FIG. 3, the cigarette 2 may include a tobacco rod 21 and a filter rod 22. The first portion and the second portion described above with reference to FIGS. 1 and 2 may include the tobacco rod 21 and the filter rod 22, respectively.

Although the filter rod 22 is illustrated as having a single segment in FIG. 3, embodiments are not limited thereto. That is, the filter rod 22 may include a plurality of segments. For example, the filter rod 22 may include a segment that cools an aerosol and a segment that filters a predetermined ingredient contained in an aerosol. In addition, the filter rod 22 may further include at least one segment that performs another function, as needed.

A diameter of the cigarette 2 may be in a range of 5 millimeters (mm) to 9 mm, and a length thereof may be about 48 mm. However, embodiments are not limited thereto. For example, a length of the tobacco rod 21 may be about 12 mm, a length of a first segment of the filter rod 22 may be about 10 mm, a length of a second segment of the filter rod 22 may be about 14 mm, and a length of a third segment of the filter rod 22 may be about 12 mm. However, embodiments are not limited thereto.

The cigarette 2 may be wrapped with at least one wrapper 24. The wrapper 24 may have at least one hole through which external air is introduced or internal gas flows out. For example, the cigarette 2 may be wrapped with one wrapper 24. As another example, the cigarette 2 may be wrapped with two or more wrappers 24 in an overlapping manner. For example, the tobacco rod 21 may be wrapped with a first wrapper 241, and the filter rod 22 may be wrapped with wrappers 242, 243, and 244. In addition, the cigarette 2 may be entirely wrapped again with a single wrapper 245. For example, when the filter rod 22 includes a plurality of segments, the plurality of segments may be wrapped with the wrappers 242, 243, and 244, respectively.

The first wrapper 241 and the second wrapper 242 may be formed of general filter wrapping paper. For example, the first wrapper 241 and the second wrapper 242 may be porous wrapping paper or non-porous wrapping paper. In addition, the first wrapper 241 and the second wrapper 242 may be formed of oilproof paper and/or an aluminum laminated wrapping material.

The third wrapper 243 may be formed of hard wrapping paper. For example, a basis weight of the third wrapper 243 may be in a range of 88 grams per square meter (g/m² to 96 g/m², and desirably, may be in a range of 90 g/m² to 94 g/m². Further, a thickness of the third wrapper 243 may be in a range of 120 micrometers (μm) to 130 μm, and desirably, may be 125 μm.

The fourth wrapper 244 may be formed of oilproof hard wrapping paper. For example, a basis weight of the fourth wrapper 244 may be in a range of 88 g/m² to 96 g/m², and desirably, may be in a range of 90 g/m² to 94 g/m². Further, a thickness of the fourth wrapper 244 may be in a range of 120 μm to 130 μm, and desirably, may be 125 μm.

The fifth wrapper 245 may be formed of sterile paper (e.g., MFW). Here, the sterile paper (MFW) may refer to paper specially prepared such that it has enhanced tensile strength, water resistance, smoothness, or the like, compared to general paper. For example, a basis weight of the fifth wrapper 245 may be in a range of 57 g/m² to 63 g/m², and desirably, may be 60 g/m². Further, a thickness of the fifth wrapper 245 may be in a range of 64 μm to 70 μm, and desirably, may be 67 μm.

The fifth wrapper 245 may have a predetermined material internally added thereto. The predetermined material may be, for example, silicon. However, embodiments are not limited thereto. Silicon may have properties, such as, for example, heat resistance which is characterized by less change by temperature, oxidation resistance which refers to resistance to oxidation, resistance to various chemicals, water repellency against water, or electrical insulation. However, silicon may not necessarily be used, and any material having such properties described above may be applied to (or used to coat) the fifth wrapper 245 without limitation.

The fifth wrapper 245 may prevent the cigarette 2 from burning. For example, there may be a probability that the cigarette 2 burns when the tobacco rod 21 is heated by the heater 13. For example, when the temperature rises above an ignition point of any one of materials included in the tobacco rod 21, the cigarette 2 may burn. Even in this example, it may still be possible to prevent the cigarette 2 from burning because the fifth wrapper 245 includes a non-combustible material.

In addition, the fifth wrapper 245 may prevent a holder from being contaminated by substances produced in the cigarette 2. For example, liquid substances may be produced in the cigarette 2 when a user puffs. For example, as an aerosol generated in the cigarette 2 is cooled by external air, liquid substances (e.g., water, etc.) may be produced. Thus, wrapping the cigarette 2 with the fifth wrapper 245 may prevent the liquid substances produced in the cigarette 2 from leaking out of the cigarette 2.

The tobacco rod 21 may include an aerosol generating material. The aerosol generating material may include, for example, at least one of glycerin, propylene glycol, ethylene glycol, dipropylene glycol, diethylene glycol, triethylene glycol, tetraethylene glycol, or oleyl alcohol. However, embodiments are not limited thereto. The tobacco rod 21 may also include other additives such as, for example, a flavoring agent, a wetting agent, and/or an organic acid. In addition, the tobacco rod 21 may include a flavoring liquid such as menthol or a moisturizing agent that is added as being sprayed onto the tobacco rod 21.

The tobacco rod 21 may be manufactured in various forms. For example, the tobacco rod 21 may be formed as a sheet or a strand. Alternatively, the tobacco rod 21 may be formed of tobacco leaves finely cut from a tobacco sheet. In addition, the tobacco rod 21 may be enveloped by a thermally conductive material. The thermally conductive material may be, for example, metal foil such as aluminum foil. However, embodiments are not limited thereto. For example, the thermally conductive material enveloping the tobacco rod 21 may evenly distribute the heat transferred to the tobacco rod 21 to improve the conductivity of the heat to be applied to the tobacco rod 21, thereby improving the taste of tobacco. In addition, the thermally conductive material enveloping the tobacco rod 21 may function as a susceptor heated by an induction heater. In this case, although not shown, the tobacco rod 21 may further include an additional susceptor in addition to the thermally conductive material enveloping the outside thereof.

The filter rod 22 may be a cellulose acetate filter. However, a shape of the filter rod 22 is not limited. For example, the filter rod 22 may be a cylindrical rod, or a tubular rod including a hollow therein. The filter rod 22 may also be a recess-type rod. For example, when the filter rod 22 includes a plurality of segments, at least one of the segments may be manufactured in a different shape.

A first segment of the filter rod 22 may be a cellulose acetate filter. For example, the first segment may be a tubular structure including a hollow therein. The first segment may prevent internal materials of the tobacco rod 21 from being pushed back when the heater 13 is inserted and generate an aerosol cooling effect. A desirable diameter of the hollow included in the first segment may be adopted from a range of 2 mm to 4.5 mm. However, embodiments are not limited thereto.

A desirable length of the first segment may be adopted from a range of 4 mm to 30 mm. However, embodiments are not limited thereto. Desirably, the length of the first segment may be 10 mm. However, embodiments are not limited thereto.

The first segment may have a hardness that is adjustable through an adjustment of the content of a plasticizer in a process of manufacturing the first segment. In addition, the first segment may be manufactured by inserting a structure such as a film or a tube of the same or different materials therein (e.g., in the hollow).

A second segment of the filter rod 22 may cool an aerosol generated as the heater 13 heats the tobacco rod 21. The user may thus inhale the aerosol cooled down to a suitable temperature.

A length or diameter of the second segment may be determined in various ways according to the shape of the cigarette 2. For example, a desirable length of the second segment may be adopted from a range of 7 mm to 20 mm. Desirably, the length of the second segment may be about 14 mm. However, embodiments are not limited thereto.

The second segment may be manufactured by weaving a polymer fiber. In this case, a flavoring liquid may be applied to a fiber formed of a polymer. Alternatively, the second segment may be manufactured by weaving a separate fiber to which a flavoring liquid is applied and the fiber formed of the polymer together. Alternatively, the second segment may be formed of a crimped polymer sheet.

For example, the polymer may be prepared with a material selected from a group consisting of polyethylene (PE), polypropylene (PP), polyvinyl chloride (PVC), polyethylene terephthalate (PET), polylactic acid (PLA), cellulose acetate (CA), and aluminum foil.

As the second segment is formed of the woven polymer fiber or the crimped polymer sheet, the second segment may include a single channel or a plurality of channels extending in a longitudinal direction. A channel used herein may refer to a path through which gas (e.g., air or aerosol) passes.

For example, the second segment formed with the crimped polymer sheet may be formed of a material having a thickness between about 5 μm and about 300 μm, for example, between about 10 μm and about 250 μm. In addition, a total surface area of the second segment may be between about 300 square millimeters per millimeter (mm²/mm) and about 1000 mm²/mm. Further, an aerosol cooling element may be formed from a material having a specific surface area between about 10 square millimeters per milligram (mm²/mg) and about 100 mm²/mg.

The second segment may include a thread containing a volatile flavor ingredient. The volatile flavor ingredient may be menthol, but is not limited thereto. For example, the thread may be filled with an amount of menthol sufficient to provide at least 1.5 mg of menthol to the second segment.

A third segment of the filter rod 22 may be a cellulose acetate filter. A desirable length of the third segment may be adopted from a range of 4 mm to 20 mm. For example, the length of the third segment may be about 12 mm. However, embodiments are not limited thereto.

The third segment may be manufactured such that a flavor is generated by spraying a flavoring liquid onto the third segment in a process of manufacturing the third segment. Alternatively, a separate fiber to which the flavoring liquid is applied may be inserted into the third segment. An aerosol generated in the tobacco rod 21 may be cooled as it passes through the second segment of the filter rod 22, and the cooled aerosol may pass through the third segment into the user. Accordingly, when a flavoring element is added to the third segment, the durability of the flavor to be carried to the user may be enhanced.

In addition, the filter rod 22 may include at least one capsule 23. Here, the capsule 23 may perform a function of generating a flavor or a function of generating an aerosol. For example, the capsule 23 may have a structure in which a liquid containing a fragrance is wrapped with a film. The capsule 23 may have a spherical or cylindrical shape. However, embodiments are not limited thereto.

Referring to FIG. 4, a cigarette 3 may further include a front end plug 33. The front end plug 33 and the filter rod 32 may be disposed on opposite sides of a tobacco rod 31. The front end plug 33 may prevent the tobacco rod 31 from falling off, and may also prevent an aerosol liquefied in the tobacco rod 31 during smoking from flowing into an aerosol generating device (e.g., the aerosol generating device 1 of FIGS. 1 and 2).

The filter rod 32 may include a first segment 321 and a second segment 322. Here, the first segment 321 may correspond to the first segment of the filter rod 22 of FIG. 3, and the second segment 322 may correspond to the third segment of the filter rod 22 of FIG. 3.

A diameter and a total length of the cigarette 3 may correspond to the diameter and the total length of the cigarette 2 of FIG. 3. For example, a length of the front end plug 33 may be about 7 mm, a length of the tobacco rod 31 may be about 15 mm, a length of the first segment 321 may be about 12 mm, and a length of the second segment 322 may be about 14 mm. However, embodiments are not limited thereto.

The cigarette 3 may be wrapped with at least one wrapper 35. The wrapper 35 may have at least one hole through which external air is introduced or internal gas flows out. For example, the front end plug 33 may be wrapped with a first wrapper 351, the tobacco rod 31 may be wrapped with a second wrapper 352, the first segment 321 may be wrapped with a third wrapper 353, and the second segment 322 may be wrapped with a fourth wrapper 354. In addition, the cigarette 3 may be entirely wrapped again with a fifth wrapper 355.

In addition, at least one perforation 36 may be formed in the fifth wrapper 355. For example, the perforation 36 may be formed in a region enclosing the tobacco rod 31. However, embodiments are not limited thereto. The perforation 36 may perform a function of transferring heat generated by the heater 13 shown in FIGS. 1 and 2 to the inside of the tobacco rod 31.

In addition, the second segment 322 may include at least one capsule 34. The capsule 34 may perform a function of generating a flavor or a function of generating an aerosol. For example, the capsule 34 may have a structure in which a liquid containing a fragrance is wrapped with a film. The capsule 34 may have a spherical or cylindrical shape, but is not limited thereto.

The first wrapper 351 may be a combination of general filter wrapping paper and metal foil such as aluminum foil. For example, a total thickness of the first wrapper 351 may be in a range of 45 μm to 55 μm, and desirably, may be 50.3 μm. Further, a thickness of the metal foil of the first wrapper 351 may be in a range of 6 μm to 7 μm, and desirably, may be 6.3 μm. In addition, a basis weight of the first wrapper 351 may be in a range of 50 g/m² to 55 g/m², and desirably, may be 53 g/m².

The second wrapper 352 and the third wrapper 353 may be formed with general filter wrapping paper. For example, the second wrapper 352 and the third wrapper 353 may be porous wrapping paper or non-porous wrapping paper.

For example, the porosity of the second wrapper 352 may be 35000 CU. However, embodiments are not limited thereto. Further, a thickness of the second wrapper 352 may be in a range of 70 μm to 80 μm, and desirably, may be 78 μm. In addition, a basis weight of the second wrapper 352 may be in a range of 20 g/m² to 25 g/m², and desirably, may be 23.5 g/m².

For example, the porosity of the third wrapper 353 may be 24000 CU. However, embodiments are not limited thereto. Further, a thickness of the third wrapper 353 may be in a range of 60 μm to 70 μm, and desirably, may be 68 μm. In addition, a basis weight of the third wrapper 353 may be in a range of 20 g/m² to 25 g/m², and desirably, may be 21 g/m².

The fourth wrapper 354 may be formed with polylactic acid (PLA) laminated paper. The PLA laminated paper may refer to three-ply paper including a paper layer, a PLA layer, and another paper layer. For example, a thickness of the fourth wrapper 354 may be in a range of 100 μm to 120 μm, and desirably, may be 110 μm. In addition, a basis weight of the fourth wrapper 354 may be in a range of 80 g/m² to 100 g/m², and desirably, may be 88 g/m².

The fifth wrapper 355 may be formed of sterile paper (e.g., MFW). Here, the sterile paper (MFW) may refer to paper specially prepared such that it has enhanced tensile strength, water resistance, smoothness, or the like, compared to general paper. For example, a basis weight of the fifth wrapper 355 may be in a range of 57 g/m² to 63 g/m², and desirably, may be 60 g/m². Further, a thickness of the fifth wrapper 355 may be in a range of 64 μm to 70 μm, and desirably, may be 67 μm.

The fifth wrapper 355 may have a predetermined material internally added thereto. The predetermined material may be, for example, silicon. However, embodiments are not limited thereto. Silicon may have properties, such as, for example, heat resistance which is characterized by less change by temperature, oxidation resistance which refers to resistance to oxidation, resistance to various chemicals, water repellency against water, or electrical insulation. However, silicon may not necessarily be used, and any material having such properties described above may be applied to (or used to coat) the fifth wrapper 355 without limitation.

The front end plug 33 may be formed of cellulose acetate. For example, the front end plug 33 may be manufactured by adding a plasticizer (e.g., triacetin) to cellulose acetate tow. A mono denier of a filament of the cellulose acetate tow may be in a range of 1.0 to 10.0, and desirably, may be in a range of 4.0 to 6.0. The mono denier of the filament of the front end plug 33 may be more desirably 5.0. In addition, a cross section of the filament of the front end plug 33 may be Y-shaped. A total denier of the front end plug 33 may be in a range of 20000 to 30000, and desirably, may be in a range of 25000 to 30000. The total denier of the front end plug 33 may be more desirably 28000.

In addition, as needed, the front end plug 33 may include at least one channel, and a cross-sectional shape of the channel may be provided in various ways.

The tobacco rod 31 may correspond to the tobacco rod 21 described above with reference to FIG. 3. Thus, a detailed description of the tobacco rod 31 will be omitted here.

The first segment 321 may be formed of cellulose acetate. For example, the first segment may be a tubular structure including a hollow therein. The first segment 321 may be manufactured by adding a plasticizer (e.g., triacetin) to cellulose acetate tow. For example, a mono denier and a total denier of the first segment 321 may be the same as the mono denier and the total denier of the front end plug 33.

The second segment 322 may be formed of cellulose acetate. A mono denier of a filament of the second segment 322 may be in a range of 1.0 to 10.0, and desirably, may be in a range of 8.0 to 10.0. The mono denier of the filament of the second segment 322 may be more desirably 9.0. In addition, a cross section of the filament of the second segment 322 may be Y-shaped. A total denier of the second segment 322 may be in a range of 20000 to 30000, and desirably, may be 25000.

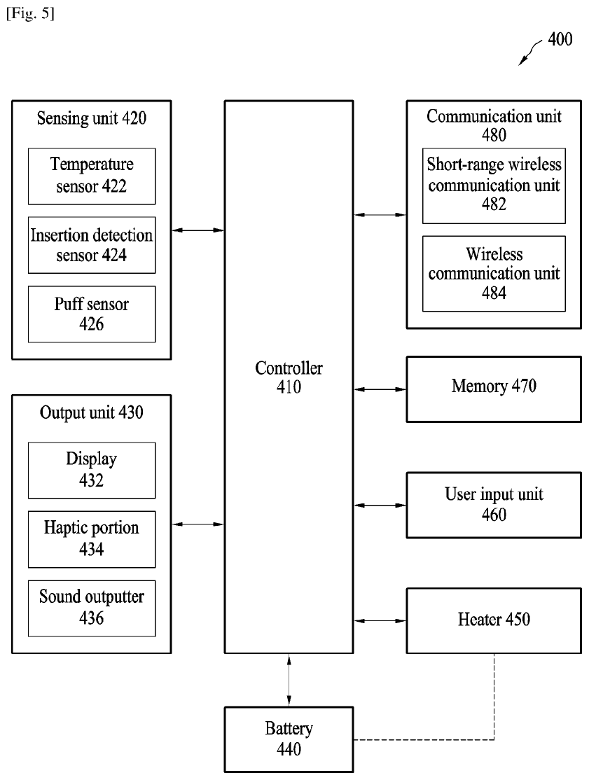

FIG. 5 is a block diagram illustrating an aerosol generating device 400 according to another embodiment.

The aerosol generating device 400 may include a controller 410, a sensing unit 420, an output unit 430, a battery 440, a heater 450, a user input unit 460, a memory 470, and a communication unit 480. However, an internal structure of the aerosol generating device 400 is not limited to what is shown in FIG. 5. It is to be understood by one of ordinary skill in the art to which the disclosure pertains that some of the components shown in FIG. 5 may be omitted or new components may be added according to the design of the aerosol generating device 400.

The sensing unit 420 may sense a state of the aerosol generating device 400 or a state of an environment around the aerosol generating device 400, and transmit sensing information obtained through the sensing to the controller 410. Based on the sensing information, the controller 410 may control the aerosol generating device 400 to control operations of the heater 450, restrict smoking, determine whether an aerosol generating article (e.g., a cigarette, a cartridge, etc.) is inserted, display a notification, and perform other functions.

The sensing unit 420 may include at least one of a temperature sensor 422, an insertion detection sensor 424, or a puff sensor 426. However, embodiments are not limited thereto.

The temperature sensor 422 may sense a temperature at which the heater 450 (or an aerosol generating material) is heated. The aerosol generating device 400 may include a separate temperature sensor for sensing the temperature of the heater 450, or the heater 450 itself may perform a function as a temperature sensor. Alternatively, the temperature sensor 422 may be arranged around the battery 440 to monitor the temperature of the battery 440.

The insertion detection sensor 424 may sense whether the aerosol generating article is inserted and/or removed. The insertion detection sensor 424 may include, for example, at least one of a film sensor, a pressure sensor, a light sensor, a resistive sensor, a capacitive sensor, an inductive sensor, or an infrared sensor, which may sense a signal change by the insertion and/or removal of the aerosol generating article.

The puff sensor 426 may sense a puff from a user based on various physical changes in an airflow path or airflow channel. For example, the puff sensor 426 may sense the puff from the user based on any one of a temperature change, a flow change, a voltage change, and a pressure change.

The sensing unit 420 may further include at least one of a temperature/humidity sensor, an atmospheric pressure sensor, a magnetic sensor, an acceleration sensor, a gyroscope sensor, a position sensor (e.g., a global positioning system (GPS)), a proximity sensor, or a red, green, blue (RGB) sensor (e.g., an illuminance sensor), in addition to the sensors 422 to 426 described above. A function of each sensor may be intuitively inferable from its name by one of ordinary skill in the art, and thus, a more detailed description thereof will be omitted here.

The output unit 430 may output information about the state of the aerosol generating device 400 and provide the information to the user. The output unit 430 may include at least one of a display 432, a haptic portion 434, or a sound outputter 436. However, embodiments are not limited thereto. When the display 432 and a touchpad are provided in a layered structure to form a touchscreen, the display 432 may be used as an input device in addition to an output device.

The display 432 may visually provide information about the aerosol generating device 400 to the user. The information about the aerosol generating device 400 may include, for example, a charging/discharging state of the battery 440 of the aerosol generating device 400, a preheating state of the heater 450, an insertion/removal state of the aerosol generating article, a limited usage state (e.g., an abnormal article detected) of the aerosol generating device 400, or the like, and the display 432 may externally output the information. The display 432 may be, for example, a liquid-crystal display panel (LCD), an organic light-emitting display panel (OLED), or the like. The display 432 may also be in the form of a light-emitting diode (LED) device.

The haptic portion 434 may provide information about the aerosol generating device 400 to the user in a haptic way by converting an electrical signal into a mechanical stimulus or an electrical stimulus. The haptic portion 434 may include, for example, a motor, a piezoelectric element, or an electrical stimulation device.

The sound outputter 436 may provide information about the aerosol generating device 400 to the user in an auditory way. For example, the sound outputter 436 may convert an electrical signal into a sound signal and externally output the sound signal.

The battery 440 may supply power to be used to operate the aerosol generating device 400. The battery 440 may supply power to heat the heater 450. In addition, the battery 440 may supply power required for operations of the other components (e.g., the sensing unit 420, the output unit 430, the user input unit 460, the memory 470, and the communication unit 480) included in the aerosol generating device 400. The battery 440 may be a rechargeable battery or a disposable battery. The battery 440 may be, for example, a lithium polymer (LiPoly) battery. However, embodiments are not limited thereto.

The heater 450 may receive power from the battery 440 to heat the aerosol generating material. Although not shown in FIG. 5, the aerosol generating device 400 may further include a power conversion circuit (e.g., a direct current (DC)-to-DC (DC/DC) converter) that converts power of the battery 440 and supplies the power to the heater 450. In addition, when the aerosol generating device 400 generates an aerosol in an induction heating manner, the aerosol generating device 400 may further include a DC-to-alternating current (AC) (DC/AC) converter that converts DC power of the battery 440 into AC power.

The controller 410, the sensing unit 420, the output unit 430, the user input unit 460, the memory 470, and the communication unit 480 may receive power from the battery 440 to perform functions. Although not shown in FIG. 5, a power conversion circuit, for example, a low dropout (LDO) circuit or a voltage regulator circuit, which converts power of the battery 440 and supplies the power to respective components, may further be included.

In an embodiment, the heater 450 may be formed of any suitable electrically resistive material. The electrically resistive material may be a metal or a metal alloy including, for example, titanium, zirconium, tantalum, platinum, nickel, cobalt, chromium, hafnium, niobium, molybdenum, tungsten, tin, gallium, manganese, iron, copper, stainless steel, nichrome, or the like. However, embodiments are not limited thereto. In addition, the heater 450 may be implemented as a metal heating wire, a metal heating plate on which an electrically conductive track is arranged, a ceramic heating structure, or the like, but is not limited thereto.

In another embodiment, the heater 450 may be an induction heater. For example, the heater 450 may include a susceptor that heats the aerosol generating material by generating heat through a magnetic field applied by a coil.

In an embodiment, the heater 450 may include a plurality of heaters. For example, the heater 450 may include a first heater for heating a cigarette and a second heater for heating a liquid.

The user input unit 460 may receive information input from the user or may output information to the user. For example, the user input unit 460 may include a keypad, a dome switch, a touchpad (e.g., a contact capacitive type, a pressure resistive film type, an infrared sensing type, a surface ultrasonic conduction type, an integral tension measurement type, a piezo effect method, etc.), a jog wheel, a jog switch, or the like. However, embodiments are not limited thereto. In addition, although not shown in FIG. 5, the aerosol generating device 400 may further include a connection interface such as a universal serial bus (USB) interface, and may be connected to another external device through the connection interface such as a USB interface to transmit and receive information or to charge the battery 440.

The memory 470, which is hardware for storing various pieces of data processed in the aerosol generating device 400, may store data processed by the controller 410 and data to be processed by the controller 410. The memory 470 may include at least one type of storage medium of a flash memory type memory, a hard disk type memory, a multimedia card micro type memory, a card type memory (e.g., an SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, or an optical disk. The memory 470 may store an operating time of the aerosol generating device 400, a maximum number of puffs, a current number of puffs, at least one temperature profile, data associated with a smoking pattern of the user, or the like.

The communication unit 480 may include at least one component for communicating with another electronic device. For example, the communication unit 480 may include a short-range wireless communication unit 482 and a wireless communication unit 484.

The short-range wireless communication unit 482 may include a Bluetooth communication unit, a Bluetooth low energy (BLE) communication unit, a near field communication unit, a wireless local area network (WLAN) wireless fidelity (Wi-Fi) communication unit, a ZigBee communication unit, an infrared data association (IrDA) communication unit, a Wi-Fi direct (WFD) communication unit, an ultra-wideband (UWB) communication unit, and an Ant+ communication unit. However, embodiments are not limited thereto.

The wireless communication unit 484 may include, for example, a cellular network communication unit, an Internet communication unit, a computer network (e.g., a LAN or a wide-area network (WAN)) communication unit, or the like. However, embodiments are not limited thereto. The wireless communication unit 484 may use subscriber information (e.g., international mobile subscriber identity (IMSI)) to identify and authenticate the aerosol generating device 400 in a communication network.

The controller 410 may control the overall operation of the aerosol generating device 400. In an embodiment, the controller 410 may include at least one processor. The processor may be implemented as an array of a plurality of logic gates, or may be implemented as a combination of a general-purpose microprocessor and a memory in which a program executable in the microprocessor is stored. In addition, it is to be understood by one of ordinary skill in the art to which the disclosure pertains that it may be implemented in other types of hardware.

The controller 410 may control the temperature of the heater 450 by controlling the supply of power from the battery 440 to the heater 450. For example, the controller 410 may control the supply of power by controlling switching of a switching element between the battery 440 and the heater 450. As another example, a direct heating circuit may control the supply of power to the heater 450 according to a control command from the controller 410.

The controller 410 may analyze a sensing result obtained by the sensing of the sensing unit 420 and control processes to be performed thereafter. For example, the controller 410 may control power to be supplied to the heater 450 to start or end an operation of the heater 450 based on the sensing result obtained by the sensing unit 420. As another example, the controller 410 may control an amount of power to be supplied to the heater 450 and a time for which the power is to be supplied, such that the heater 450 may be heated up to a predetermined temperature or maintained at a desired temperature, based on the sensing result obtained by the sensing unit 420.

The controller 410 may control the output unit 430 based on the sensing result obtained by the sensing unit 420. For example, when the number of puffs counted through the puff sensor 426 reaches a preset number, the controller 410 may inform the user that the aerosol generating device 400 is to be ended soon, through at least one of the display 432, the haptic portion 434, or the sound outputter 436.

In an embodiment, the controller 410 may control a power supply time and/or a power supply amount for the heater 450 according to a state of the aerosol generating article sensed by the sensing unit 420. For example, when the aerosol generating article is in an over-humidified state, the controller 410 may control the power supply time for an inductive coil to increase a preheating time, compared to a case where the aerosol generating article is in a general state.

An embodiment may be implemented in the form of a recording medium including instructions executable by a computer, such as a program module executable by the computer. A computer-readable medium may be any available medium that may be accessed by a computer and includes a volatile medium, a non-volatile medium, a removable medium, and a non-removable medium. In addition, the computer-readable medium may include both a computer storage medium and a communication medium. The computer storage medium includes all of a volatile medium, a non-volatile medium, a removable medium, and a non-removable medium implemented by any method or technology for storage of information such as computer-readable instructions, data structures, program modules or other data. The communication medium typically includes computer-readable instructions, data structures, other data in modulated data signals such as program modules, or other transmission mechanisms, and includes any information transfer medium.

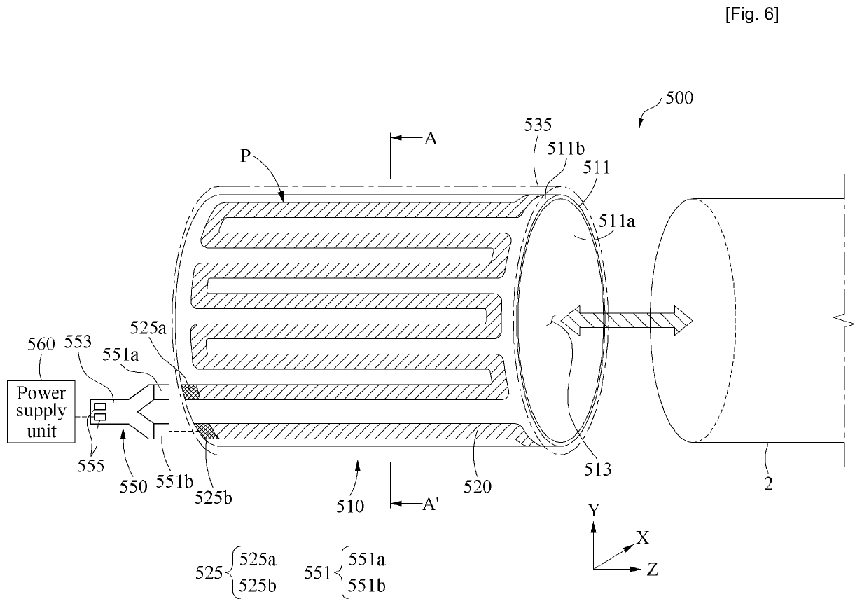

FIG. 6 is a perspective view illustrating coupling of an aerosol generating article (e.g., the cigarette 2) and an aerosol generating device 500 according to an embodiment.

Referring to FIG. 6, the aerosol generating device 500 (e.g., the aerosol generating device 1 of FIG. 1 or the aerosol generating device 400 of FIG. 5) may include one or more components of a heater 510 (e.g., the heater 13 of FIGS. 1 and 2 or the heater 450 of FIG. 5), a pipe 511, a connector 550, and a power supply unit 560. The heater 510 may include a heating wire 520 and a plurality of terminals 525.

In an embodiment, the heater 510 may heat the pipe 511 and heat an aerosol generating article such as the cigarette 2 (e.g., the cigarette 2 of FIG. 1, FIG. 2, or FIG. 3) which is inserted into the pipe 511 through an opening 513 of the pipe 511. Hereinafter, a target to be heated by the aerosol generating device 500 according to various embodiments of the disclosure refers to a cigarette, but embodiments are not limited thereto and may be implemented in various ways in an actual implementation. For example, the aerosol generating article may be the cigarette 2 or an article including a liquid composition.

In an embodiment, the pipe 511 may be a three-dimensional (3D) structure including the opening 513 into which the cigarette 2 is inserted. In an embodiment, a diameter of the opening 513 of the pipe 511 may be the same as or greater than a diameter of the cigarette 2. The cigarette 2 may be inserted into the opening 513, the heater 510 may heat the pipe 511, and the pipe 511 may heat the cigarette 2.

In an embodiment, the pipe 511 may be made of a stiff material to support the cigarette 2. Alternatively, the pipe 511 may be made of an elastic material having flexibility such that the cigarette 2 is readily inserted and withdrawn. The pipe 511 may be made of a thermally conductive material to be heated by the heater 510 and to heat the cigarette 2. For example, the pipe 511 may be a heat pipe or a metal pipe made of a metal material such as stainless steel (SUS) or copper.

In an embodiment, the pipe 511 may include a first surface 511a and a second surface 511b. The first surface 511a may be a surface that encloses at least a partial region of an outer circumferential surface of the cigarette 2 when the cigarette 2 is inserted. The second surface 511b may be a surface opposite to the first surface 511a. For example, the first surface 511a may be an inner surface of the pipe 511, and the second surface 511b may be an outer surface of the pipe 511.

In an embodiment, the heater 510 may be provided on the second surface 511b of the pipe 511. For example, the heater 510 may be placed to enclose at least a partial region of the second surface 511b of the pipe 511 and may heat a plurality of regions of the pipe 511.

In an embodiment, the heater 510 may include a heating wire 520 and a plurality of terminals 525. The heater 510 is briefly described above for ease of description but is not limited thereto and may further include various elements in an actual implementation.

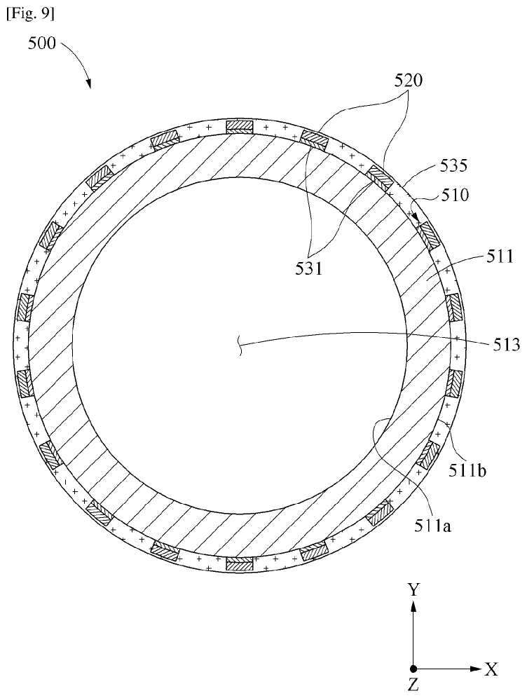

In an embodiment, the heating wire 520 may be printed on the second surface 511b in pattern P enclosing at least a partial region of the second surface 511b of the pipe 511. Although not shown in FIG. 6, an insulating layer (e.g., an insulating layer 531 of FIG. 8) for electrical insulation may be provided between the second surface 511b and the heating wire 520, and the heating wire 520 may be printed directly on the insulating layer 531 and/or the second surface 511b. A coating layer 535 may be placed on an outer side of the second surface 511b of the pipe 511 and the heating wire 520. The coating layer 535 may be applied such that the second surface 511b of the pipe 511 and/or the heating wire 520 is not exposed to the outside.

In an embodiment, the heating wire 520 may be patterned or printed on the second surface 511b of the pipe 511 or on the second surface 511b and the insulating layer 531. For example, the heating wire 520 may be printed on the pipe 511 through a 3D printer or a 3D patterning device.

In an embodiment, the plurality of terminals 525 may include a first terminal 525a and a second terminal 525b. For example, the first terminal 525a may be a positive electrode (+) terminal, and the second terminal 525b may be a negative electrode (−) terminal, or vice versa. In an embodiment, the plurality of terminals 525 may be attached to or printed on the second surface 511b of the pipe 511. Each of the plurality of terminals 525 may be connected to a different part of the heating wire 520 and may connect the connector 550 and the heating wire 520.

In an embodiment, the connector 550 may be connected to the power supply unit 560 and may supply power from the power supply unit 560 to the heater 510. The connector 550 may be a cable or a printed circuit board (PCB) and may be a separate component that is distinct from the pipe 511 and the heater 510.

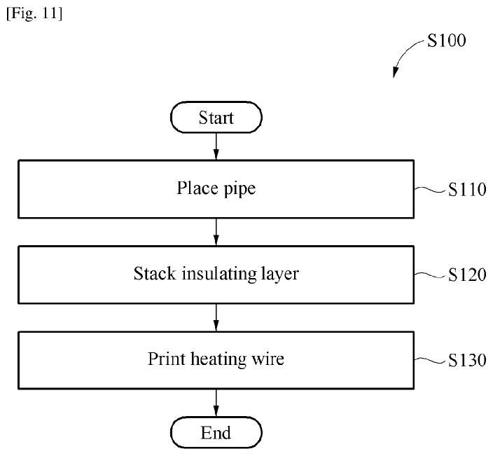

For example, the pipe 511 and the heater 510 may be integrally or inseparably formed through a manufacturing process (e.g., a method S100 of manufacturing the aerosol generating device 500 of FIG. 11). The connector 550 may be formed separately from the pipe 511 and the heater 510 and electrically connected to the integrated heater 510 and the pipe 511 through the terminal 525 of the heater 510.

In an embodiment, the connector 550 may include a first connector terminal 551a, a second connector terminal 551b, a third connector terminal 555, and a body 553. In an embodiment, the first connector terminal 551a may be connected to the first terminal 525a of the heater 510, and the second connector terminal 551b may be connected to the second terminal 525b of the heater 510. The third connector terminal 555 may be connected to the power supply unit 560 and may be implemented as a plurality of contact pads.

In an embodiment, the body 553 may have a structure that extends from the third connector terminal 555 to the first connector terminal 551a and the second connector terminal 551b. The body 553 may be formed of a flexible PCB (FPCB). Since the first terminal 525a and the second terminal 525b of the heater 510 are provided on a 3D structure of the pipe 511, the body 553 of the connector 550 implemented as an FPCB may be properly connected to the first terminal 525a and the second terminal 525b.

In an embodiment, the body 553 of the connector 550 may extend toward the first connector terminal 551a, the second connector terminal 551b, and the third connector terminal 555 from a center so as to form a Y-shape. The connector 550 having the body 553 formed in a Y-shape may be advantageous in obtaining flexibility enabling the connector 550 to be connected to the first terminal 525a and the second terminal 525b. The connector 550 having the body 553 formed in a Y-shape may be universally used for the first terminal 525a and the second terminal 525b with various arrangement structures.

In an embodiment, when the heater 510 is implemented with the heating wire 520 and the plurality of terminals 525, one of the power supply unit 560 and the connector 550 may control power supplied to the heater 510.

For example, the power supply unit 560 may apply power to the heater 510 and control the applied power. The power supply unit 560 may be a battery (e.g., the battery 11 of FIGS. 1 and 2) and/or a controller (e.g., the controller 12 of FIGS. 1 and 2). Alternatively, the power supply unit 560 may function to supply power, and the connector 550 may include a separate integrated circuit (IC) and control driving of the heater 510.

In an embodiment, when the power is supplied to the heater 510 through the connector 550, a current flows along the heating wire 520, and the pipe 511 may be heated. If the heater 510 has a structure that is manufactured separately and then coupled to the pipe 511, in other words, if a direct printing scheme is not used, the aerosol generating device 500 may need a separate connecting member (not shown) to interconnect the pipe 511 and the heater 510. Also, in an embodiment, since the pipe 511 may deform as the pipe 511 is repeatedly used or as the cigarette 2 is inserted, a separate shrinkable tube (not shown) may be provided such that the pipe 511 and the heater 510 are in close contact with each other.

In an embodiment of the present disclosure, as the heating wire 520 of the heater 510 is printed directly on the second surface 511b of the pipe 511, the aerosol generating device 500 may closely connect the heater 510 and the pipe 511 even if the separate connecting member (not shown) or the shrinkable tube (not shown) is not included. As such, a structure of the pipe 511 and the heater 510 for heating the cigarette 2 may be simplified, and thus the aerosol generating device 500 may provide economic feasibility for manufacturing and manufacturing efficiency.

In an embodiment of the present disclosure, as the heating wire 520 of the heater 510 is printed directly on the second surface 511b of the pipe 511, the pipe 511 and the heater 510 may be integrally formed. Heat generated by the heating wire 520 may be directly transferred to the pipe 511 without passing through another member (e.g., a sheath of the heating wire 520, an adhesive member, etc.) between the heating wire 520 and the pipe 511. Therefore, the aerosol generating device 500 may provide thermal efficiency through an integrated structure of the heater 510 and the pipe 511.

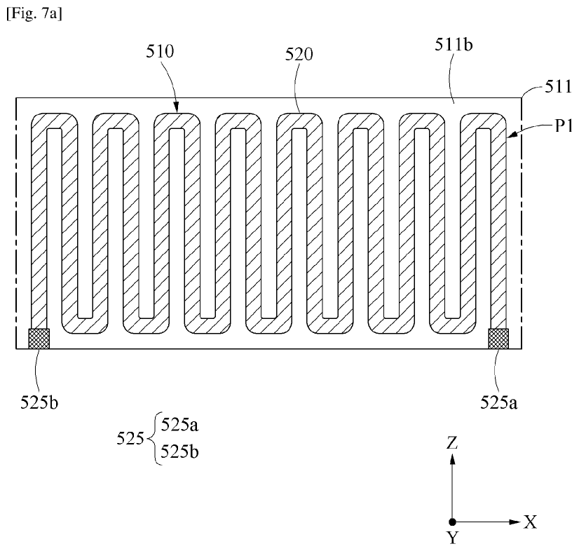

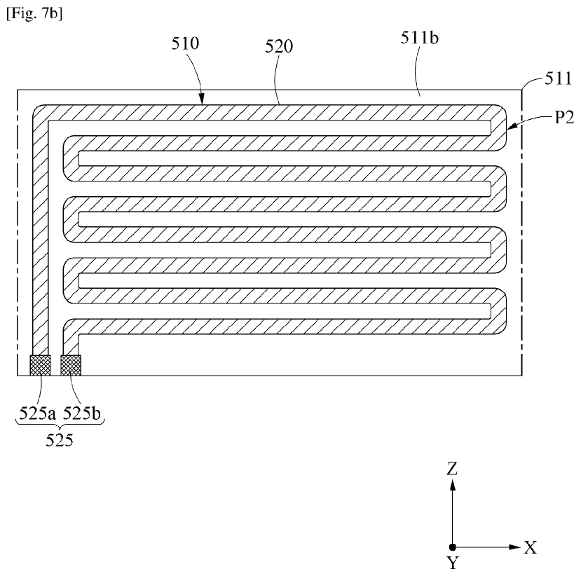

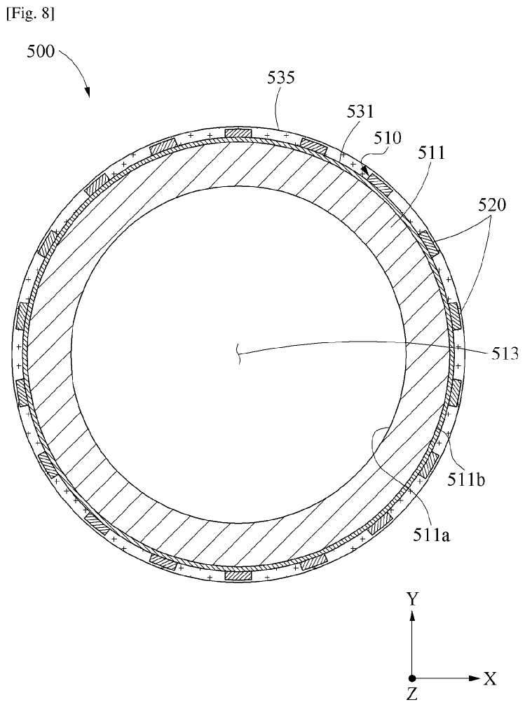

FIG. 7a is a planar figure of the pipe 511 and the heater 510 according to an embodiment, and FIG. 7b is a planar figure of the pipe 511 and the heater 510 according to an embodiment.

For example, FIGS. 7a and 7b may be planar figured of the second surface 511b of the pipe 511 of FIG. 6. That is, end portions at both sides (e.g., both edges on the X axis) of FIGS. 7a and 7b may be connected to each other or the same region in the 3D structure of the pipe 511.

Referring to FIGS. 7a and 7b, the heating wire 520 may be printed in a pattern (e.g., a first pattern P1 and a second pattern P2) enclosing at least a partial region of a circumferential surface (i.e., side surface) of the pipe 511.

In an embodiment, the heating wire 520 may form a closed loop through which a current flows in one direction. For example, the heating wire 520 may include one end portion connected to the first terminal 525a and another end portion opposite to the one end portion and connected to the second terminal 525b. The current may flow in a direction from the first terminal 525a to the second terminal 525b or in a direction from the second terminal 525b to the first terminal 525a through the heating wire 520. As the current flows, a temperature of the heating wire 520 rises, and the heating wire 520 may heat a surrounding material such as the pipe 511.

In an embodiment, as illustrated in FIG. 7a, the heating wire 520 may be printed on the second surface 511b of the pipe 511 in the first pattern P1. The first pattern P1 may be a pattern of which a main printing direction is a longitudinal direction (e.g., a Z-axis direction) of the pipe 511.

In an embodiment, as illustrated in FIG. 7b, the heating wire 520 may be printed on the second surface 511b of the pipe 511 in the second pattern P2. The second pattern P2 may be a pattern of which a main printing direction is a circumferential direction (e.g., an X-axis direction) of the pipe 511.

In an embodiment of the present disclosure, the heating wire 520 may be printed on the pipe 511 in the various patterns P1 and P2. For example, the heating wire 520 may be printed on the second surface 511b of the pipe 511 in a predetermined pattern. A heating part of the pipe 511 and/or the cigarette 2 may be targeted depending on a printed pattern shape. In various embodiments, the heating wire 520 may be variously designed based on a longitudinal direction, a circumferential direction, or a diagonal direction of the pipe 511 and may set a target heating region and a heating differential region by considering a shape or a structure of the cigarette 2 and the aerosol generating device 500.

FIG. 8 is a cross-sectional view of the aerosol generating device 500 according to an embodiment.

Referring to FIG. 8, the aerosol generating device 500 according to an embodiment may include at least one of the insulating layer 531 and the coating layer 535.

In an embodiment, the insulating layer 531 for electrical insulation may be provided between the heater 510 and the pipe 511. For example, the insulating layer 531 may be deposited on the second surface 511b of the pipe 511, and the heating wire 520 of the heater 510 may be printed on the insulating layer 531. The insulating layer 531 may electrically isolate the heater 510 and the pipe 511 from each other such that the current flowing through the heating wire 520 is not lost to the pipe 511 or not short-circuited. The coating layer 535 may be made of a material with high thermal conductivity.

In an embodiment, the coating layer 535 may be deposited on the second surface 511b of the pipe 511 and the heating wire 520. The coating layer 535 may protect the heating wire 520 such that the heating wire 520 does not contact other components. In the aerosol generating device 500 according to various embodiments of the present disclosure, since the heating wire 520 is printed directly on the pipe 511, the heating wire 520 may be exposed on the second surface 511b, which is an outer circumferential surface of the pipe 511. The coating layer 535 may shield the heating wire 520 and/or the pipe 511 such that the heating wire 520 and/or the pipe 511 does not contact other materials.

In an embodiment, although FIG. 8 illustrates that the coating layer 535 has substantially a circumferential surface corresponding to the second surface 511b of the pipe 511, embodiments are not limited thereto in an actual implementation. For example, the coating layer 535 may be substantially deposited on the second surface 511b and the heating wire 520 with a uniform width.

In an embodiment, the insulating layer 531 and/or the coating layer 535 may be made of a nonconductor to block a current from flowing. In an embodiment, materials of the coating layer 535 and the insulating layer 531 may be substantially the same or similar to each other. Alternatively, the coating layer 535 may be made of a thermosetting material or an insulating material. Alternatively, the coating layer 535 may be made of a material with high thermal conductivity such that heat of the heater 510 may be diffused through the coating layer 535, and the second surface 511b of the pipe 511 may be uniformly heated.

In an embodiment, the insulating layer 531 and/or the coating layer 535 may be implemented as a thin film or a thinly deposited insulating material. Although FIG. 8 illustrates that the insulating layer 531 and the coating layer 535 have a certain thickness, the insulating layer 531 and/or the coating layer 535 may be implemented as a thin film or layer in an actual implementation.

In an embodiment, the insulating layer 531 may be stacked on substantially an entire region of the second surface 511b in a circumferential direction of the pipe 511. Accordingly, in a method (e.g., the method S100 of manufacturing the aerosol generating device 100 of FIG. 11) of manufacturing the aerosol generating device 500, a process of forming the insulating layer 531 may be facilitated. Also, it may be possible to prevent issues caused by separation or a defect of the heating wire 520.

FIG. 9 is a cross-sectional view of the aerosol generating device 500 according to an embodiment.

Referring to FIG. 9, the insulating layer 531 according to an embodiment may be formed in a partial region of the second surface 511b. In the description of FIG. 9, any repeated description related to the above descriptions is omitted.

In an embodiment, the insulating layer 531 may be stacked on a partial region of the second surface 511b in a circumferential direction of the pipe 511. For example, the insulating layer 531 may be stacked on a region in the second surface 511b of the pipe 511, the region corresponding to pattern P in which the heating wire 520 is printed.

In an embodiment, in a method (e.g., the method S100 of manufacturing the aerosol generating device 100 of FIG. 11) of manufacturing the aerosol generating device 500, the insulating layer 531 may serve as a guide pattern for printing the heating wire 520. When using a 3D printer capable of stacking different materials, the pipe 511 and the heater 510 may be integrated by depositing the insulating layer 531 made of an insulating material and then depositing the heating wire 520 made of a conductive material.

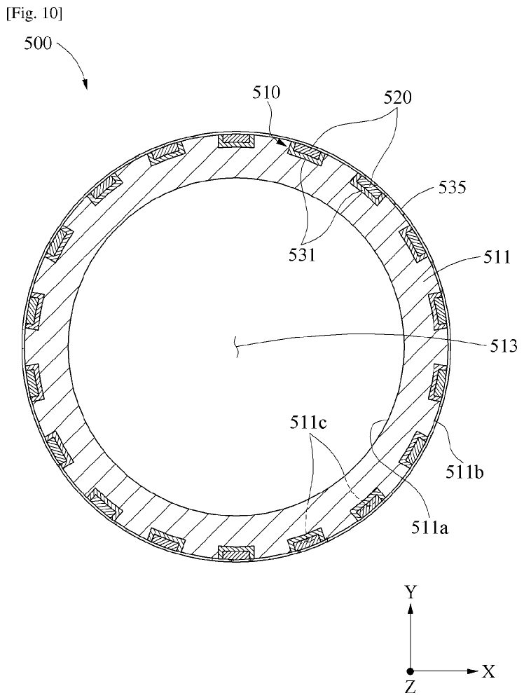

FIG. 10 is a cross-sectional view of the aerosol generating device 500 according to an embodiment.

Referring to FIG. 10, the pipe 511 may include a groove 511c. In the description of FIG. 10, any repeated description related to the above descriptions is omitted.

In an embodiment, the groove 511c may be formed on the second surface 511b of the pipe 511. The groove 511c may be inwardly recessed to correspond to pattern P in which the heating wire 520 is printed. In an embodiment, the insulating layer 531 and/or the heating wire 520 may be placed in the groove 511c.

In an embodiment, the insulating layer 531 may be deposited in the groove 511c. Although FIG. 10 illustrates that the insulating layer 531 is formed in the groove 511c but not elsewhere, embodiments are not limited thereto in an actual implementation. As illustrated in FIG. 8, the insulating layer 531 may be stacked on substantially an entire region of the second surface 511b of the pipe 511.

In an embodiment, the heating wire 520 and the insulating layer 531 may be placed in the groove 511c. When the heating wire 520 is placed in the groove 511c, the heating wire 520 may heat a side wall of the grove 511c in addition to a bottom of the groove 551c. Thus, the aerosol generating device 500 may provide improved heat transfer efficiency. In an embodiment, the second surface 511b of the pipe 511 may be formed so as to be substantially flat.

FIG. 11 is a flowchart of a method of manufacturing the aerosol generating device 500 according to an embodiment.

Referring to FIG. 11, according to an embodiment, the method S100 of manufacturing the aerosol generating device 500 may include at least some of operation S110 of placing the pipe 511, operation S120 of stacking the insulating layer 531, and operation S130 of printing the heating wire 520.

In an embodiment, in the method S100 of manufacturing the aerosol generating device 500, a target to be manufactured may be at least one of the above-described aerosol generating devices (e.g., the aerosol generating device 500), but embodiments are not limited thereto.

In operation S110, the pipe 511 may be placed at a designated position, for example, on a 3D printer. The pipe 511 may include the opening 513, the first surface 511a (i.e., inner surface), and the second surface 511b opposite to the first surface 511a. A 3D printer may be a device capable of depositing or printing a pattern on a 3D object by spraying a solid material or a liquid onto the object.

In operation S120, the insulating layer 531 may be stacked on the second surface 511b of the pipe 511. In an embodiment, the insulating layer 531 may be stacked on substantially an entire region of the second surface 511b along a circumferential direction of the pipe 511.

For example, the insulating layer 531 may be implemented by attaching a film made of an insulating material to the second surface 511b of the pipe 511. Alternatively, the insulating layer 531 may be implemented by printing a solid material made of an insulating material or spraying a liquid material and then solidifying the liquid material on the second surface 511b of the pipe 511.

In an embodiment, in operation S120 of stacking the insulating layer 531, the insulating layer 531 may be stacked on a region in the second surface 511b of the pipe 511, the region corresponding to pattern P in which the heating wire 520 is printed. For example, the insulating layer 531 may be implemented by attaching, to the second surface 511b of the pipe 511, a film made of an insulating material and having a shape corresponding to a shape of the pattern P of the heating wire 520. Alternatively, the insulating layer 531 may be implemented by printing a solid material made of an insulating material or spraying a liquid material on the second surface 511b of the pipe 511 according to the pattern P of the heating wire 520 and then solidifying the liquid material.

In operation S130, the heating wire 520 may be printed on the insulating layer 531 on the second surface 511b of the pipe 511. For example, the heating wire 520 may be substantially integrated with the pipe 511 by printing a conductive solid material or a liquid material on the pipe 511 placed on the 3D printer.

In an embodiment, the heating wire 520 may be printed directly on the second surface 511b and/or the insulating layer 531 in the pattern P enclosing at least a partial region of the second surface 511b of the pipe 511. Unlike various embodiments of the present disclosure, if the heating wire 520 is not printed directly on the pipe 511, a separate adhesive member (not shown) and/or an insulating member (not shown), such as a sheath, may be further required for the heating wire 520 to be attached to the second surface 511b of the pipe 511 after the heating wire 520 is generated. In this case, other materials may reduce heat transfer efficiency, manufacturing processes may be added, and the aerosol generating device 500 may have a complex structure.

In various embodiments of the present disclosure, as the heating wire 520 is printed directly on the second surface 511b of the pipe 511, relatively improved heat transfer efficiency may be provided, a manufacturing process may be simplified, and the aerosol generating device 500 may have a simple structure.

In an embodiment, the method S100 of manufacturing the aerosol generating device 500 may further include an operation (not shown) of forming the groove 511c before operation S110 of placing the pipe 511. In the operation (not shown) of forming the groove 511c, on the second surface 511b of the pipe 511, the groove 511c may be inwardly formed to correspond to the pattern P of the heating wire 520. In an embodiment, the groove 511c may be formed through a process of partially cutting the pipe 511 or may be formed during a molding process of the pipe 511. The insulating layer 531 and/or the heating wire 520 may be placed in the groove 511c.

In an embodiment, the method S100 of manufacturing the aerosol generating device 500 may further include an operation (not shown) of depositing the coating layer 535 after operation S130 of printing the heating wire 520. In operation S130 of depositing of the coating layer 535, the coating layer 535 may be deposited on the second surface 511b of the pipe 511 and the heating wire 520. The coating layer 535 may protect the second surface 511b of the pipe 511 and the heating wire 520 such that the second surface 511b of the pipe 511 and the heating wire 520 are not exposed to the outside.

Although the embodiments have been described with reference to the limited drawings, one of ordinary skill in the art may apply various technical modifications and variations based thereon. For example, suitable results may be achieved if the described techniques are performed in a different order and/or if components in a described system, architecture, device, or circuit are combined in a different manner or replaced or supplemented by other components or their equivalents. Therefore, other implementations, other embodiments, and equivalents of the claims are within the scope of the following claims.

1. An aerosol generating device for generating an aerosol by heating a cigarette, the aerosol generating device comprising:
a pipe comprising an opening into which the cigarette is inserted, a first surface enclosing at least a partial region of an outer circumferential surface of the cigarette when the cigarette is inserted, and a second surface opposite to the first surface;
a heater provided on the second surface of the pipe and configured to heat the pipe; and
an insulating layer configured to provide electrical insulation and arranged between the heater and the second surface of the pipe,
wherein the heater comprises a heating wire printed directly on at least one of the second surface and the insulating layer in a pattern enclosing at least a partial region of the second surface of the pipe.

2. The aerosol generating device of claim 1, wherein
the aerosol generating device comprises a connector configured to supply power to the heater, and
the heater comprises a plurality of terminals comprising a first terminal and a second terminal each connected to the connector.

3. The aerosol generating device of claim 2, wherein the heating wire comprises one end portion connected to the first terminal and another end portion connected to the second terminal, the other end portion being opposite to the one end portion.

4. The aerosol generating device of claim 2, wherein
the aerosol generating device comprises a power supply unit connected to the connector and configured to supply power to the heater, and the connector comprises:
a first connector terminal connected to the first terminal;
a second connector terminal connected to the second terminal;
a third connector terminal connected to the power supply unit; and
a body made of a flexible printed circuit board (FPCB) and extending from the third connector terminal to the first connector terminal and the second connector terminal.

5. The aerosol generating device of claim 4, wherein the body of the connector extends toward the first connector terminal, the second connector terminal, and the third connector terminal from a center so as to form a Y-shape.

6. The aerosol generating device of claim 1, wherein the aerosol generating device comprises a coating layer deposited on the second surface of the pipe and the heating wire.

7. The aerosol generating device of claim 1, wherein the insulating layer is stacked on substantially an entire region of the second surface of the pipe.

8. The aerosol generating device of claim 1, wherein the insulating layer is stacked on a partial region of the second surface of the pipe, the partial region corresponding to the pattern in which the heating wire is printed.

9. The aerosol generating device of claim 1, wherein the pipe comprises, on the second surface, a groove inwardly formed to correspond to the pattern in which the heating wire is printed.

10. The aerosol generating device of claim 9, wherein the insulating layer and the heating wire are placed in the groove on the second surface of the pipe.

11. A method of manufacturing an aerosol generating device, the method comprising:
placing a pipe comprising an opening, an inner surface, and an outer surface opposite to the inner surface;
stacking an insulating layer on the outer surface of the pipe; and
printing a heating wire on the insulating layer,
wherein the printing of the heating wire comprises printing the heating wire directly on at least one of the outer surface and the insulating layer in a pattern enclosing at least a partial region of the second surface of the pipe.

12. The method of claim 11, wherein the stacking of the insulating layer comprises stacking the insulating layer on substantially an entire region of the outer surface of the pipe.

13. The method of claim 11, wherein the stacking of the insulating layer comprises stacking the insulating layer on a partial region of the outer surface of the pipe, the region corresponding to the pattern in which the heating wire is printed.

14. The method of claim 11, comprising:
before the placing of the pipe, forming, on the outer surface of the pipe, a groove inwardly formed to correspond to the pattern in which the heating wire is printed.

15. The method of claim 11, comprising:
after the printing of the heating wire, depositing a coating layer on the outer surface of the pipe and the heating wire.
